(19) United States
(12) Patent Application Publication
(10) Pub. No.: US 2018/0320455 A1
(43) Pub. Date: Nov. 8, 2018

(54) WELLSITE CASING WITH INTEGRATED COUPLING AND METHOD OF MAKING SAME

(71) Applicant: RDT, Inc., Beasley, TX (US)

(72) Inventors: Darren Edward MOURRE, Spring, TX (US); Thein H. AUNG, Houston, TX (US); R. Thomas MOORE, College Station, TX (US); Michael Ray LANE, Washington, TX (US)

(73) Assignee: RDT, Inc., Beasley, TX (US)

(21) Appl. No.: 15/768,188

(22) PCT Filed: Oct. 14, 2016
(86) PCT No.: PCT/US16/57183

§ 371 Date: Apr. 13, 2018

Related U.S. Application Data
(60) Provisional application No. 62/242,974, filed on Oct. 16, 2015.

(51) Int. Cl. E21B 17/042; E21B 33/14; E21B 19/16; F16L 15/00; E21B 17/08

(52) U.S. Cl. CPC E21B 17/042; E21B 33/14; E21B 17/08; F16L 15/00; E21B 19/16

(57) ABSTRACT

An integrated casing joint, casing assembly, and method is disclosed. The integrated casing includes a tubular portion and a pair of tubular joint ends. The pair of tubular joint ends are positionable at opposite ends of the tubular portion. At least one of the pair of tubular joint ends includes an upset end integrally formed with the tubular portion. The upset end has equivalent mechanical strength with the tubular portion, and is matably connectable to one of the pair of tubular joint ends of an adjacent casing joint to define an integrated casing connection therebetween whereby casing performance is optimized.

### CROSS-REFERENCE TO RELATED APPLICATION

The application claims the benefit of U.S. Provisional Application No. 62/242,974, filed on Oct. 16, 2015, the entire contents of which are hereby incorporated by reference herein.

### BACKGROUND

This present disclosure relates generally to oilfield technology. More specifically, the present disclosure relates to casing used in wellbores.

Casing is deployed into wellbores to line and support portions of the wellbore. Casing is a series of steel casing joints (or tubes) connected together to form a casing string that is advanced into the wellbore from a surface rig to line the wellbore.

The casing joints each have threaded ends connected to a threaded coupling. The threaded coupling joins pairs of casing joints together to form the casing string. The casing string is used to line and isolate portions of the wellbore. The casing string is secured in the wellbore by cement. Cement may be disposed in an annulus between the casing and a wall of the wellbore to adhere the casing in place in the wellbore.

Examples of casing are provided in U.S. Pat. Nos. 619,821, 3,870,351, 4,153,283, 4,988,127, 7,347,459, and 20120279709, the entire contents of which are hereby incorporated by reference herein.

Despite the advancements in casing, there remains a need for further advancements to prevent failures of casing in the wellbore.

### SUMMARY

In at least one aspect, the disclosure relates to an integrated casing joint of a casing string positionable in a wellbore penetrating a subterranean formation. The integrated casing joint comprises a tubular portion, and a pair of tubular joint ends positionable at opposite ends of the tubular portion. At least one of the pair of tubular joint ends comprises an upset end integrally formed with the tubular portion. The upset end has equivalent mechanical strength with the tubular portion. The upset end matably connects to one of the pair of tubular joint ends of an adjacent casing joint to define an integrated casing connection therebetween whereby casing performance is optimized.

The upset end may comprise a box end having an outer diameter larger than an outer diameter of the tubular portion with a tapered shoulder defined therebetween. The other of the pair of tubular joint ends may comprise a pin end. The pin end may be an upset pin end or a coupled pin end. The upset end may have a tapered inner surface with a minimum inner diameter larger than an inner diameter of the tubular portion with an internal shoulder defined therebetween. The internal shoulder may be perpendicular, tapered, angled, or curved. At least one of the pair of tubular joint ends may have threads matably connectable to threads of at least one of the pair of tubular joint ends of another adjacent casing joint. The upset end may also comprise a hardener.

The tubular portion may comprise a green tube, a seamless tube, a flat metal rolled into a tube, and/or a seamed tube. The tubular portion may comprise a metal alloy. The metal alloy comprises between 0.22 and 0.29 Carbon, between 0.7 and 1.45 Manganese, between 0.15 and 0.35 Silicon, between 0.30 and 1.20 Chrome, between 0.15 and 0.5 Molybdenum, and between 0.02 and 0.05 Aluminum, and/or combinations thereof. The equivalent mechanical strength may comprise torque strength, tensile strength, compression pressure strength, and/or combinations thereof.

In another aspect, the present disclosure relates to an integrated casing assembly positionable in a wellbore penetrating a subterranean formation. The integrated casing assembly comprises a plurality of casing joints matingly connected in series to form a casing string. Each of the casing joints comprises a tubular portion and a pair of tubular joint ends positionable at opposite ends of the tubular portion. At least one of the pair of tubular joint ends comprises an upset end integrally formed with the tubular portion. The upset end has equivalent mechanical strength with the tubular portion. The upset end is matably connectable to one of the pair of tubular joint ends of an adjacent casing joint to define an integrated casing connection therebetween whereby casing performance is optimized.

At least one adjacent pair of the plurality of casing joints may comprise integrated casing joints defining an integrated connection therebetween. At least one adjacent pair of the plurality of casing joints may comprise coupled casing joints defining a coupled connection therebetween. The integrated casing assembly may also comprise at least one coupling connectable between the adjacent pair of the coupled casing joints.

Each of the plurality of casing joints may have different diameters telescopically connected together. The plurality of casing joints may define a variable casing string length. The integrated casing assembly may also comprise a seal between the plurality of casing joints. The adjacent casing joint may have an adjacent end receivable in the upset end. The adjacent end may have a tapered outer surface with a shoulder shaped to receivingly engage the upset end. The upset end may have an outer diameter larger than an outer diameter of the adjacent end to define a step therebetween.

Finally, in another aspect, the present disclosure relates to a method of performing an integrated casing operation for a wellbore penetrating a subterranean formation. The method involves providing an integrated casing joint comprising a tubular portion and a pair of tubular joint ends positionable at opposite ends of the tubular portion. At least one of the pair of tubular joint ends comprises an upset end integrally formed with the tubular portion. The upset end has equivalent mechanical strength with the tubular portion. The method also involves forming an integrated casing string by matingly connecting at least one of the pair of tubular joint ends of the integrated casing joint with an end of another casing joint. The method continues with advancing the integrated casing string into the wellbore and cementing the integrated casing string in the wellbore.

The providing may also involve forming the integrated casing joint. The forming may involve machining a green tube from a tubing material, forming a raw joint by upsetting at least one end of the green tube, forming a completed joint by heat treating the raw joint, and finishing the completed joint.

The machining may comprise rolling out the tubular portion and heating the tubular portion to a forging temperature. The forming the raw joint may comprise forging the upset end in an upset mold at a forging temperature, cooling the upset end to ambient temperature, and inspecting the upset end. The forming the completed joint may comprise heating the raw joint and cooling the raw joint. The finishing may comprise applying threading, hardener, stenciling, coating, inspecting, measuring, weighing, grading, drifting, and/or combinations thereof.

The method may also involve supporting the integrated casing string during connection with an integrated casing connection. The method may also involve maintaining connection between adjacent casing connections during application of forces to the integrated casing string. The method may also involve heat treating and finishing the tubular portion and the pair of tubular joint ends.

### BRIEF DESCRIPTION OF THE DRAWINGS

So that the above recited features and advantages can be understood in detail, a more particular description, briefly summarized above, may be had by reference to the embodiments thereof that are illustrated in the appended drawings. It is to be noted, however, that the examples illustrated are not to be considered limiting of its scope. The figures are not necessarily to scale and certain features and certain views of the figures may be shown exaggerated in scale or in schematic in the interest of clarity and conciseness.

FIG. 1 is a schematic diagram of a wellsite having a casing string deployed into a wellbore, the casing string comprising coupled casing joints and integrated casing joints with casing connections between the various casing joints.

FIG. 2 is an exploded view of the coupled casing joint.

FIGS. 3A-3C are plan views of various integrated casing joints.

FIGS. 4A-4B 5A-5B, and 6A-6B are longitudinal cross-sectional views of various integrated connections between integrated casing joints.

FIGS. 7A, 7B1, 7B2, and 7C are flow charts depicting various methods of performing casing operations, including a method of making an integrated casing joint, a detailed method of making an integrated casing joint, and a method of casing a wellbore, respectively.

FIG. 8 is a schematic diagram depicting features of the casing joint.

### DETAILED DESCRIPTION

In the following description, numerous details are set forth to provide an understanding of the present disclosure. However, it will be understood by those skilled in the art that the present disclosure may be practiced without these details and that numerous variations or modifications from the described embodiments are possible.

The present disclosure relates to integrated casing joints connectable in series to form a casing string deployable into a wellbore. The integrated casing joint includes a tubing including a tubular portion with upset ends matable with an adjacent casing joint to form an integrated connection therebetween. The tubing may have a chemical composition comprising a metal alloy formed from raw metal (e.g., an electric resistance welding (ERW), green tube, etc.). The ends may be upset into the shape of box and/or pin ends by using a predefined upsetting process (e.g., heating to a forging temperature, molding to specified dimension, etc.). The upsetting may also be defined to provide mechanical properties (e.g., yield strength, tensile strength, collapse pressure, etc.) at the ends that are consistent with (e.g., approximately the same as) those along the tubing portion adjacent thereto.

The chemical composition, upset process, and consistent mechanical properties may be defined with the intent to optimize casing performance characteristics (e.g., make-up torque, tension yield, pressure capacity, etc.), for example, by providing strength (e.g., torque strength, tensile strength, etc.) about the integrated connections, preventing leakage resulting from flexion at the connections, eliminating gaps about connections, reducing stress along the casing string, preventing buckling, reducing mechanical failure at the coupling, preventing unthreading, reducing the amount of connections required along the casing string, reducing the amount of radial obstruction along the casing string, and/or optionally foregoing the need for a separate casing connector to join the mated ends. The casing joints may also be provided with other features, such as hardeners and/or seals about portions of the casing joints and/or string.

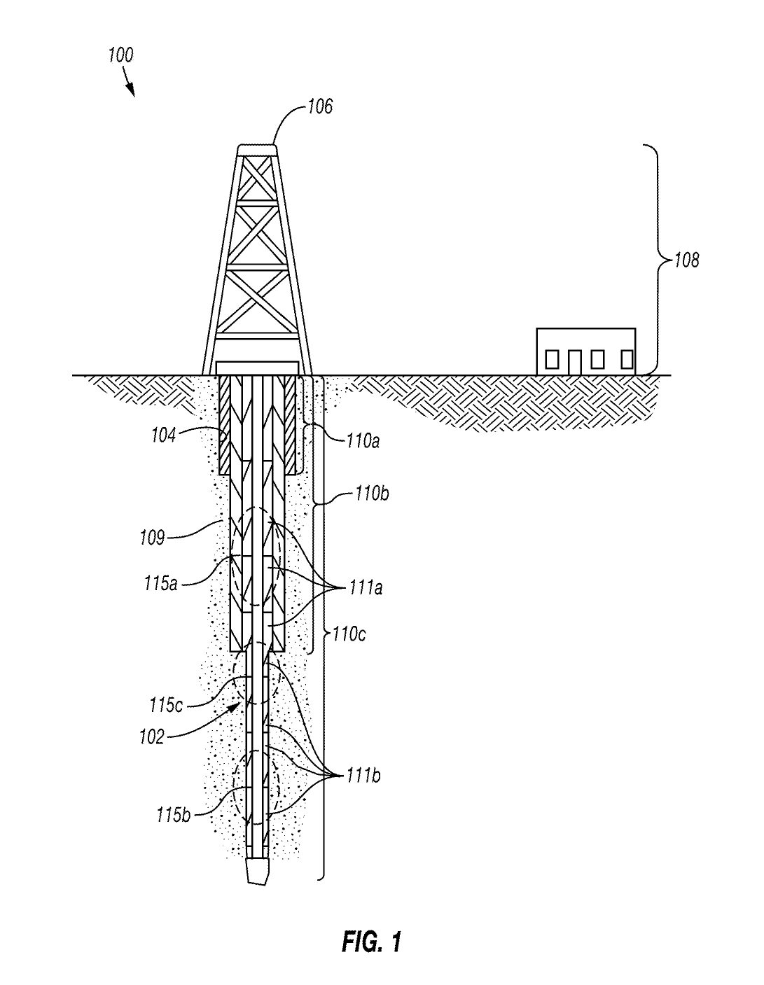

FIG. 1 is a schematic diagram of a production wellsite 100 with a casing string 102 deployed into a wellbore 104. While the wellsite 100 is depicted as a land based wellsite, any wellsite (e.g. onshore or offshore) may be used. The wellsite 100 includes a rig 106 and surface equipment 108. The casing string 102 may be deployed from the rig 106 by rig equipment (e.g., elevators, top drives, and/or other conveyance). The casing 102 may be positioned in the wellbore 104 during drilling or after the wellbore 104 is formed. The casing string 102 may be secured to the wellbore 104 with a cement 109 to form a seal with the formation.

In the example shown, the casing string 102 includes multiple concentric casing sections 110a-c made of a plurality of casing joints 111a,b. The concentric casing sections 110a-c may have a variety of diameters such that the smaller diameter casing sections are deployable through the wider diameter casing sections. As shown, the hole sizes and corresponding casing sections 110a-c may become smaller as the depth of wellbore goes deeper. For example, casing section 110c is smaller than casing section 110b which is smaller than casing section 110a, such that casing sections 110b,c are deployable through casing section 110a and casing section 110c is deployable through casing section 110b. The size of the casing string 102 and/or joints 111a,b may be determined based on the hole size drilled.

The casing sections 110a-c may be coupled to allow telescoping of the various casing sections to form an elongate casing string 102. The overall length of the casing string 102 may be extended to a length of casing section 110a plus casing section 110b plus casing section 110c. One or more of the casing sections 110a-c may be deployed to form the casing string 102. As the wellbore 104 is drilled, additional casing sections may be added as needed.

The casing string 102 also includes coupled casing joints 111a and integrated casing joints 111b. One or more of the coupled and/or integrated casing joints 111a,b may be used with one or more casing sections 110a-c to form the casing string 102. Casing connections 115a-c are defined between adjacent casing joints. The casing connections 115a-c may include a coupled connection 115a between coupled casing joints 111a, integrated connections 115b between integrated casing joints 111b, or a combination connection 115c between the coupled casing joint 111a and the integrated casing joint 111b.

The casing joints and/or strings provided herein may be used for a variety of purposes, such as for casing drilling in which the casing string is deployed with a drilling tool at an end thereof. The casing tubing may also be used for passage of fluid and/or equipment therethrough, for example, during hydraulic fracturing string, flow back strings, testing strings, acidizing strings, intervention strings, completions strings, landing strings, as well as used for clean-out operations. Other applications may be non-oilfield related such as water well drilling, river crossings, construction pilings and various other operations where maintaining structural integrity of a casing string may be needed.

The casing connections 115b-c may be defined to provide support to the casing string during connection (e.g., application of torque during formation of the casing connections), to handle even high forces, stress points, and/or flexing applied to the casing string (e.g., bending, torque, etc.) as is described further herein. The integrated casing joints and integrated casing connections may be defined with the intent to optimize casing performance as is also described further herein.

FIG. 2 is an exploded view showing the coupled casing joint 111a in greater detail. The coupled casing joint 111a of FIG. 2 includes two tubings 212 threadedly connected to a coupling 214. The tubing 212 may be a steel tube having a tubular portion 216 with tapered threaded pin ends 218 on each end thereof. The coupling 214 has mated threads 220 to matingly receive the threaded ends 218 to form the mated, coupled connection 115a therebetween. The pin ends 218 may be conventionally threaded to form a threaded and coupled (T&C) connection.

The coupled casing joint 111a may be a conventional casing joint, such as those described in U.S. Pat. Nos. 619,821, 3,870,351, 4,153,283, 4,988,127, 7,347,459, and 20120279709.

### Integrated Casing Joints

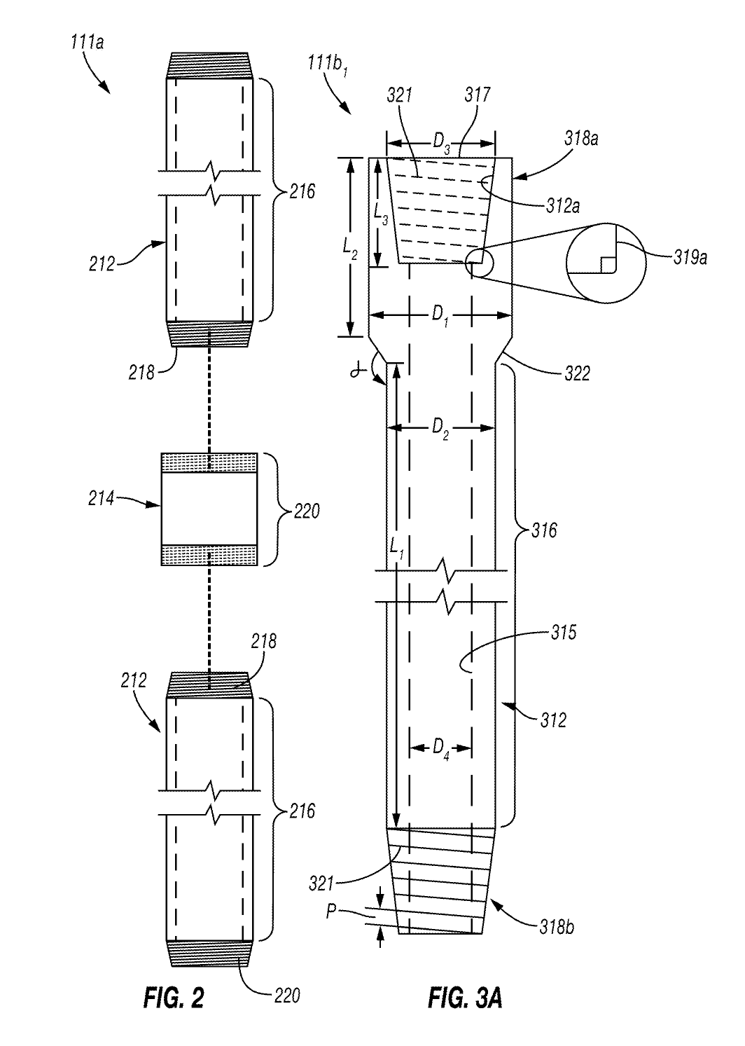

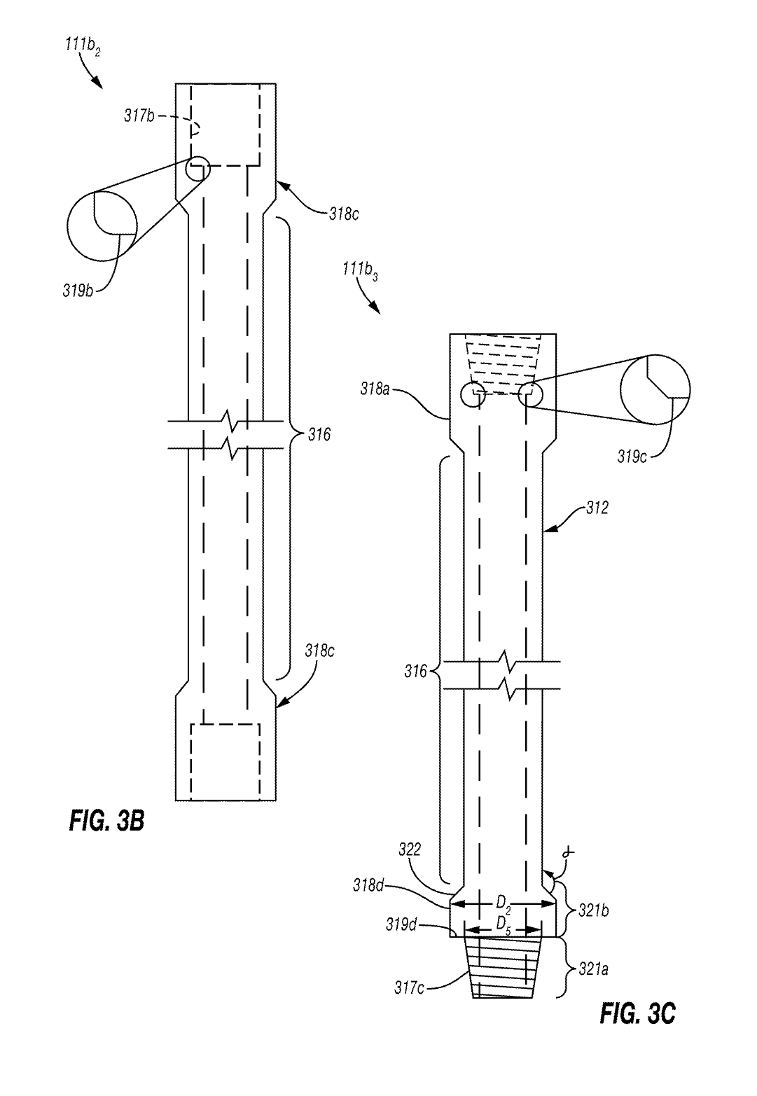

FIGS. 3A-3C show various versions of the integrated casing joint 111b that may be used to form a casing string. FIG. 3A shows a single upset, unthreaded casing joint 111b1. FIG. 3B shows a dual, upset unthreaded casing joint 111b2. FIG. 3C shows a dual upset, threaded casing joint 111b3. The example integrated casing joints 111b1-b3 of FIGS. 3A-3C each include the tubing 312 having one or more of the integrated ends 318a,b,c.

The tubing 312 may be a metal tubing formed from a metal material, such as a green tube (ERW or seamless). The metal material may be a flat metal (e.g., ERW) rolled and seamed to form raw tubing, or a seamless tube (e.g., seamless green tube) pre-formed into the raw tubing. The raw tubing may be made of various materials, such as steel, alloy, or other metals, such as carbon, manganese, phosphorus, sulfur, silicon, copper, nickel, chrome, molybdenum, tin, aluminum, vanadium, niobium, titanium, boron, nitrogen, and/or other metals. As set forth in the examples herein, combinations of certain metals may be used to provide the casing performance characteristics in the resulting casing joints, namely: Carbon (e.g., about 0.22-0.29), Manganese (e.g., about 0.7-1.45), Silicon (e.g., about 0.15-0.35), Chrome (e.g., about 0.30-1.20), Molybdenum (e.g., about 0.15-0.5), Aluminum (e.g., about 0.02-0.05), or subsets of these ranges.

Portions of the tube, ends, connections, upsets, threads, and/or other portions of the casing joint may be made of various materials, such as those specified by API (American Petroleum Institute), a manufacturer, end user, and/or other specification. Part or all of the casing joints may be of the same or different materials. As described further herein, a selected chemical composition of the tubing may be defined to achieve desired casing performance characteristics of the casing joint and/or casing string.

The casing joints may also be provided with upsets formed, for example, from seamless and ERW tubing. Upsetting may involve forming the casing joint using upsetting, heat treating, and finishing to define a specific shape and dimension of the casing. Upsetting may be performed, for example, along one or both ends of the tubing to form the integrated connections. One or more of the integrated casing joints may be combined to form the casing connections 115b-c.

The tubing 312 may be processed to define a tubular portion 316 with integrated ends 318a,b at each end thereof and a passage 315 therethrough. The integrated ends 318a,b may be in the form of box ends 318a and/or pin ends 318b, separately formed and subsequently integrated with the tubing 312 (e.g., by bonding, welding, etc.). The ends 318a,b may be formed by upsetting ends of the tubing 312 as is described further herein. The ends 318a,b may be defined such that they incorporate the features of the coupling into the casing joint, thereby eliminating the requirement of a separate coupling and allowing direct connection between ends of adjacent casing joints.

In the single upset, threaded version of the casing joint 111b1 of FIG. 3A, the tubing 312 has integrated pin and box ends 318a,b. The integrated box end 318a is upset to define an enlarged outer diameter D1 with a tapered shoulder 322 extending from the outer diameter D1 to a smaller outer diameter D2 defined by the tubing 312. The tapered shoulder 322 is at an angle α from the tubing 312. The angle and dimension of the upset may be defined to provide an incline to facilitate passage of the casing joint through the wellbore and/or to prevent hanging up (e.g., stuck in hole)

The box end 318a has an opening 317a shaped to receive a pin end of another casing joint (e.g., 111a,b). Threads 321 are provided along an inner surface of the box end 318a to matingly engage threads from the end of the other casing joint. In the example shown, the internal opening 317a has a conical shape extending from an end of the box to an internal shoulder 319a a distance therein. The internal shoulder 319a may act as a stop to terminate advancement of the pin end 318b during connection. The shoulders may be of various shapes, such as perpendicular, tapered, angled, curved, etc. and at various dimensions. The pin ends may be shaped to conform to the shoulders. In the version of FIG. 3A, the shoulder 319a is a right angle (perpendicular) shoulder.

The pin end 318b may have a tapered outer surface with threads 321 thereon for connection to a coupling (e.g., 214) and/or adjacent box end 318a. Threads 321 of the box and pin ends 318a,b may be provided with compatible pitches P for threaded connection therebetween. The threads 321 or other connection features, such as various openings, tapers, grooves, shoulders, hardeners, and/or other features, may be provided for matable connection with an adjacent casing joint to form a connection therebetween as is described further herein.

The integrated casing joints herein may have a variety of dimensions usable in a variety of casing applications. The casing joints may have dimensions to provide grades such as (but not limited to) RDT 95, RDT CY95, RDT P110, RDT P110CY, RDT P110E, RDT Q-125, RDT Q-125E, RDT Q-125CY, RDT S-135, RDT S-135CY. For example, the tubular portion 316 may have a length L1 of from about 25 to about 45 in (63.5 to 114.3 cm), the diameter D2 of from about 5.5 to about 5.55 in (13.97 to 14.10 cm), and an internal diameter of passage 315 of from about 4.65 to about 4.60 (11.81 to 11.68 cm); the box end 318a may have a length L2 of from about 7 to about 8 inches (17.78 to 20.32 cm) and the diameter D1 of from about 6.400 to about 6.500 in (16.26 to 16.51 cm); the box end 318a may have the internal threaded opening having a length L3 of from about 4 to about 5 in (10.16 to 12.7 cm) and an inner diameter D3 of from about 4.600 to about 4.700 in (11.68 to 11.94 cm); internal and external shoulders 219a,b may have a width W of from about 0.125 in (0.3175 cm); and/or the shoulder 322 may have about 1.5 in (3.81 cm) taper at an angle α of about 150-170 degrees.

In the dual upset, unthreaded version of the casing joint 111b2 of FIG. 3B, the tubing 312 has upset box ends 318c formed on each end of the tubing 316. The box ends 318c are the same the box ends 318a as in FIG. 3A, except that the opening 317b has no threads and has a curved shoulder 319b. In this version, the opening 317b may allow for a press fit, friction weld, bonded, and/or other connection.

In the dual upset, threaded version of the casing joint 111b3 of FIG. 3C, the tubing 312 has upset box and pin ends 318c,d formed on each end of the tubular portion 316. The box end 318a is the same as in FIG. 3A, except with an angled shoulder 319c. Threads 321 are provided about the box and pin ends as in FIG. 3A.

In this version, the pin end 318c is upset to define a threaded portion 321a and an upset portion 321b with a shoulder 319d defined therebetween. The upset portion has an enlarged outer diameter D2 with a tapered shoulder 322 extending from the diameter D2 to the tubular portion 316 at the angle α similar. The outer surface 317c of the threaded portion 321a has a diameter D5 adjacent the threaded portion 321a that is less than the diameter D2 to define the shoulder 319d therebetween. The outer surface 317c of the threaded portion 321b tapers away from the shoulder 322 to a terminal end of the pin end 318d. The pin end 318d is depicted as being upset similar to the upset of 318b with similar diameter and angle, but optionally may be different.

While FIGS. 3A-3C depict specific configurations of the integrated casing joint 111b1-b3, it will be appreciated that variations in dimensions, shapes, and optional features may be provided to achieve the integrated connections with the capabilities provided herein.

### Integrated Connection

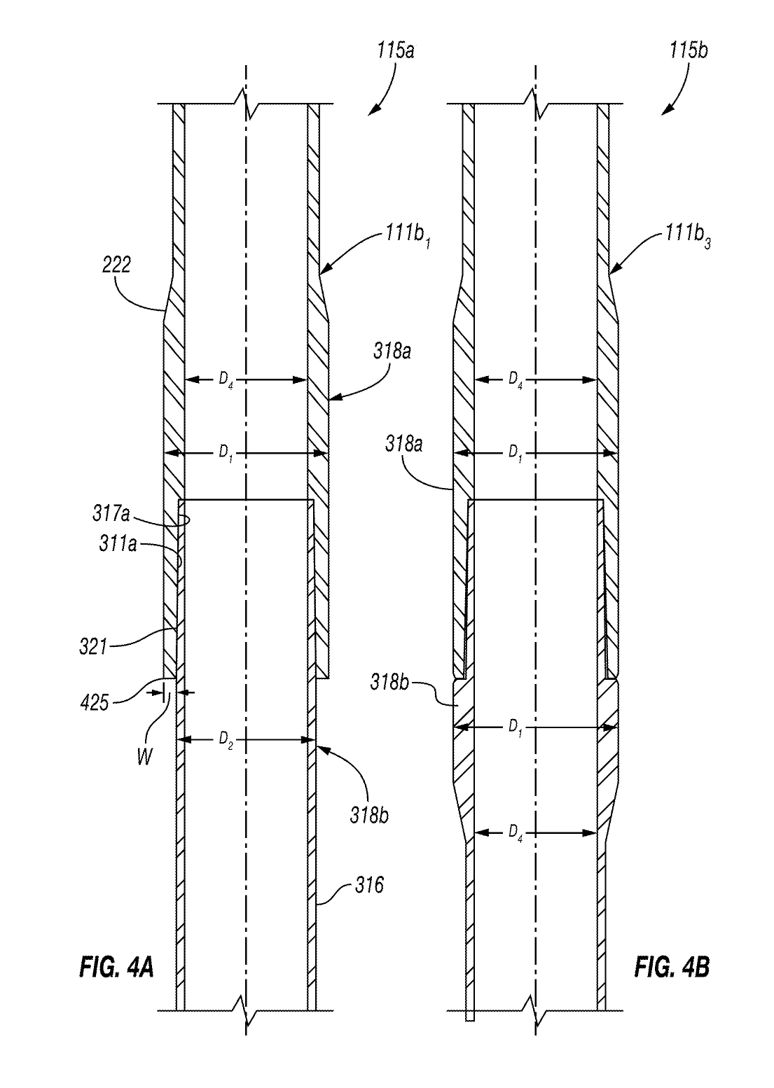

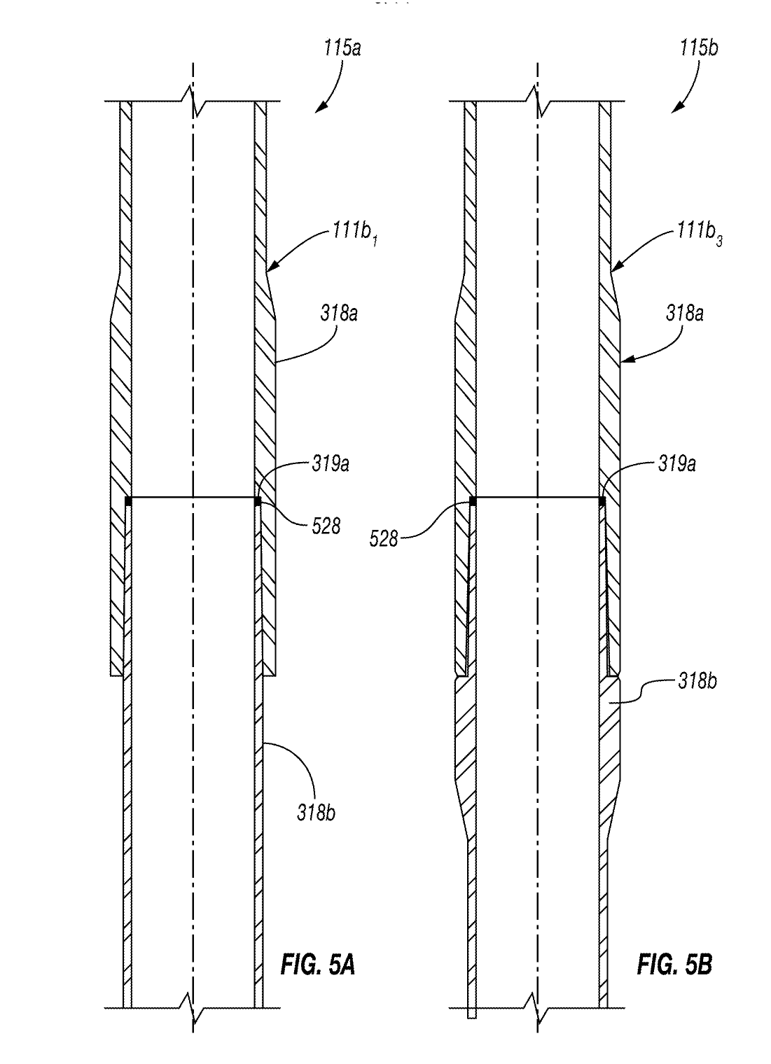

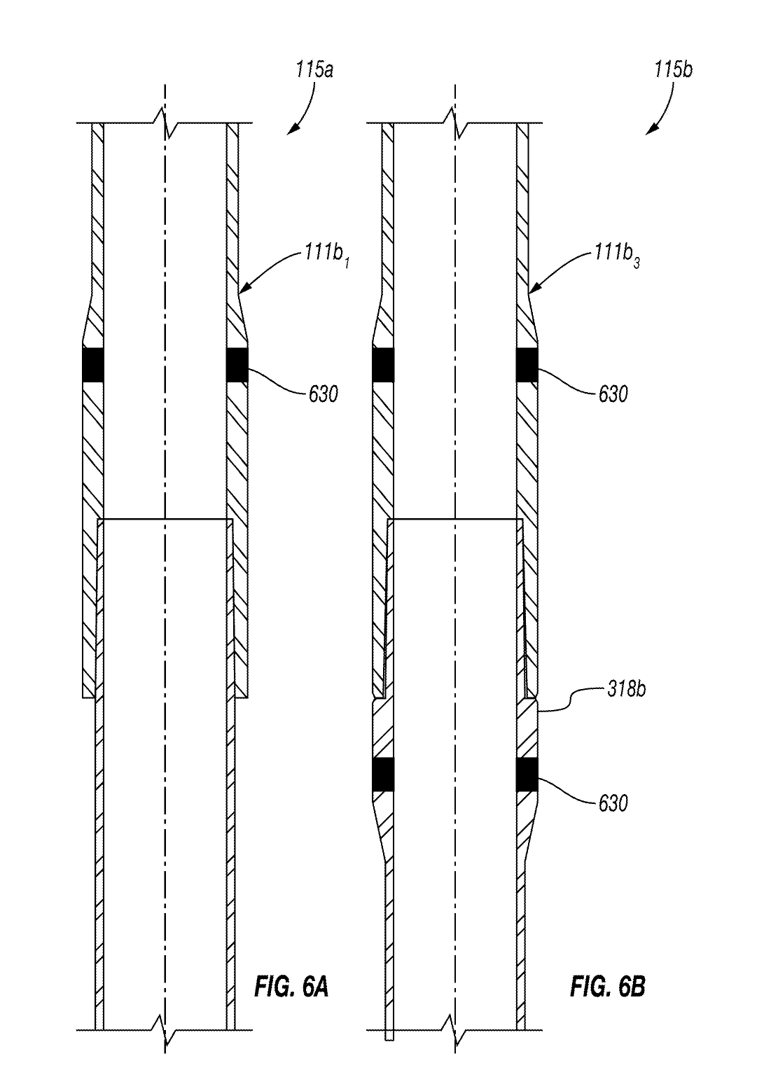

FIGS. 4A-6B show integrated casing connections 115a,b between various casing joints 111b1,b3 with optional features. FIGS. 4A-4B show the casing connections 115a,b, with FIGS. 5A-5B adding a seal and FIGS. 6A-6B adding a hardener (e.g., hardbanding).

FIG. 4A shows an integrated connection 115a formed between a pair of the integrated, single upset casing joints 111b1. The integrated connection 115a is formed by threading the box end 318a of a first integrated casing joint 111b1 to the pin end 318b of a second integrated casing joint. As shown in this view, the pin end 318b is received in the opening 317a of the integrated casing joint 111b1. The pin end 318b is threadedly matable with the threads 221 of the opening 317a.

The inner surface of the casing joints 111b1 aligns to provide the constant inner diameter D4 through the integrated connection 115a. The diameter D1 along the outer surface of the box end 318a is greater than the diameter D2 defined by the pin end 318b and tubular portion 216 of the adjacent casing joint resulting in a step 425 having a width W of about 0.125 in (0.32 cm) along the outer surface of the integrated connection 115a.

FIG. 4B is similar to FIG. 4A, except that the integrated connection 115b is formed between a pair of the integrated, dual upset casing joints 111b3. In this version, the pin end 318b is also upset of corresponding dimension to the box end 318a, thereby providing a constant diameter D1 as well as the constant inner diameter D4 across the integrated connection 115b (without the step 425).

FIGS. 5A and 5B are the same as FIGS. 4A and 4B, except that a seal 528 is provided along the integrated connections 115a,b. The seal 528 may be a metal-to-meal seal positioned between the end of the pin end 318b/d, and the internal 319a shoulder of the box end 318a. The seal 528 may be positioned to provide pressure integrity and/or to prevent leakage between the pin and box ends 318a,b/d. The seal 528 may be one or more separate components positioned between the pin and box ends 318a,b/d, or be an extension of the pin and/or box ends 318a,b. If formed as an extension, the seal 528 may be excess material along the pin and/or box ends 318a,b available during the forming of the upset.

FIGS. 6A and 6B are the same as FIGS. 4A and 4B, except that a hardener 630 has been provided along the casing joints 111a,b. As shown, the hardener 630 may be applied to the outer surface of the upset box end 318a and/or upset pin end 318b. The hardener may be integrated into a portion of the casing joints and/or applied thereto. The hardener may be various materials applied in bands at one or more locations along the casing joints. Examples of hardeners that may be used are described, for example, in U.S. Pat. No. 8,783,344.

### Manufacture of Integrated Connections

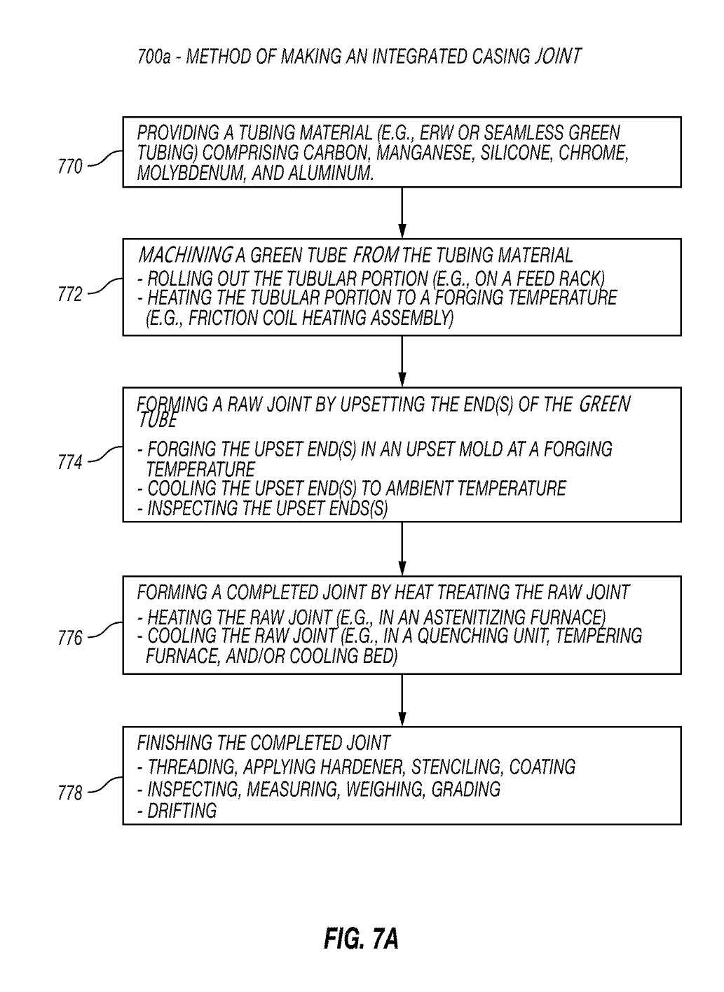

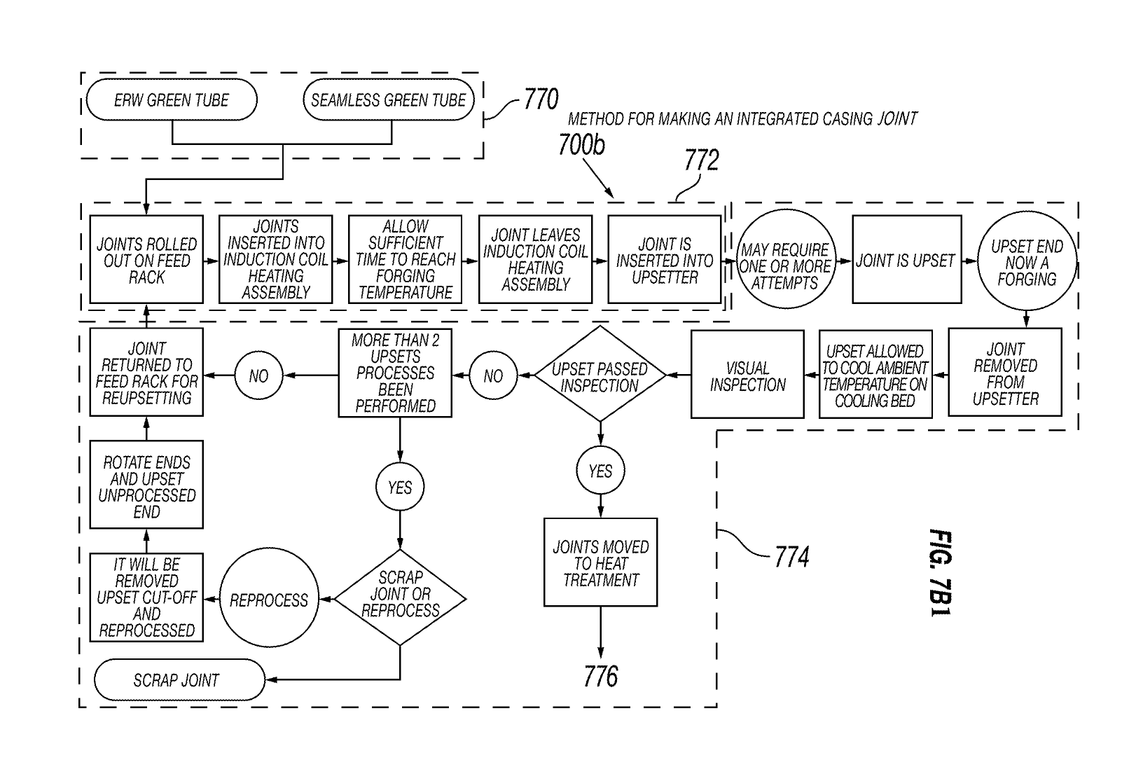

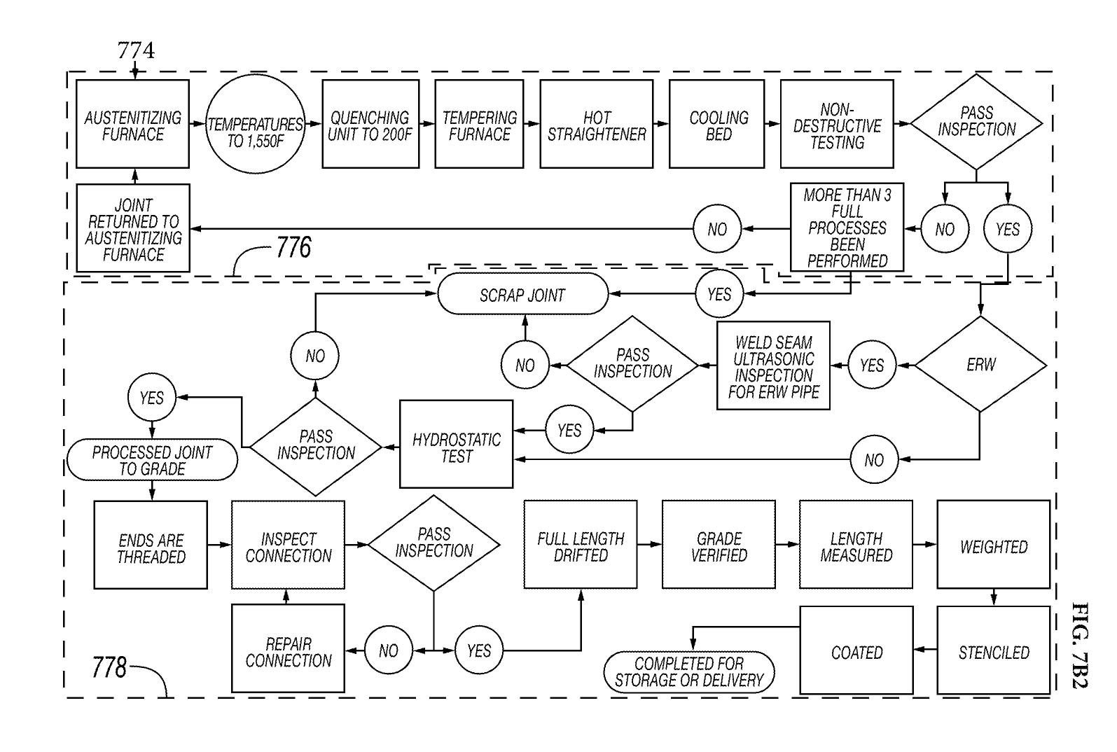

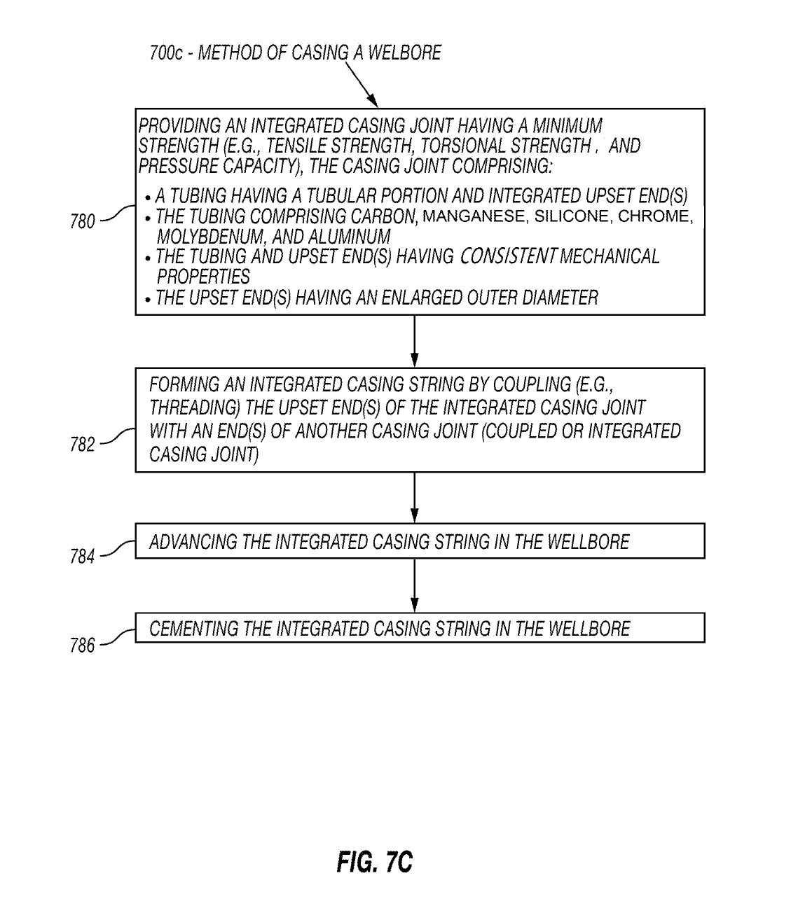

FIGS. 7A, 7B1, 7B2, and 7C show various methods that may be used with the integrated casing joints. FIG. 7A shows an example method 700a of making the integrated casing joints. FIGS. 7B1 and 7B2 show a detailed view of an example method 700b. FIG. 7C shows a method 700c of casing a wellbore using an integrated casing joint.

As shown in FIGS. 7A and 7B1-7B2, the method 700a involves 770—providing tubing material, 772—machining a green tube from the tubing material, 774—forming a raw joint by upsetting ends) of the green tube, 776—forming a completed joint by heat treating the raw joint, and 778—finishing the completed joint.

The providing 770 may involve providing a metal material, such as a steel or green tubing. The type of tubing (e.g., J-55 grade) may be specified by an end user. For example, the metal material may be obtained in the form of seamless or slit (ERW) tubing. For seamless applications, solid steel, tubular rounds (or billets) may be provided. The seamless rounds may be cut to a specified length. ERW may be less expensive than equivalent seamless tubing. For ERW applications, an ERW green tube may be formed from steel sheets or coils that may be slit or cut to the precise width required for the related size that is to be built.

The tubing may be made of a metal alloy comprising carbon, manganese, silicone, chrome, molybdenum, aluminum, and/or other metals. By way of example, the casing joint may be formed from an ERW green tube having the metallurgy as set forth in Table 1 below, or a seamless green tube having the metallurgy as set forth in Table 2 below:

TABLE 1
ERW Green Tube - PR-15

| Element | Min | Max |
|---|---|---|
| Carbon | 0.2200 | 0.2600 |
| Manganese | 1.2500 | 1.4500 |
| Phosphorus | — | 0.0150 |
| Sulfur | — | 0.0080 |
| Silicon | 0.1600 | 0.2200 |
| Copper | — | 0.1600 |
| Nickel | — | 0.0800 |
| Chrome | 0.3000 | 0.4000 |
| Molybdenum | 0.1500 | 0.2000 |
| Tin (Sn) | — | 0.0200 |
| Aluminum | 0.0200 | 0.0600 |
| Vanadium | — | 0.0100 |
| Niobium | — | 0.0100 |
| Titanium | — | 0.0100 |
| Boron | — | 0.0010 |
| Nitrogen | — | 0.0120 |

TABLE 2
Seamless Green Tube - PR-14

| Element | Min | Max |
|---|---|---|
| Carbon | 0.2500 | 0.2900 |
| Manganese | 0.7000 | 0.9000 |
| Phosphorus | — | 0.0150 |
| Sulfur | — | 0.0050 |
| Silicon | 0.1500 | 0.3500 |
| Copper | — | 0.2000 |
| Nickel | — | |
| Chrome | 1.0000 | 1.2000 |
| Molybdenum | 0.4000 | 0.5000 |
| Tin (Sn) | — | — |
| Aluminum | 0.0150 | 0.0500 |
| Vanadium | — | 0.0500 |

To achieve desired casing performance characteristics, the chemical make up of the tubing may be selected. For example, specific material chemistries of the tubing may be selected to optimize the material properties along the tubing, as well as to maintain these optimized properties in the ends which have been upset and which have increased material thickness and machining (e.g., threads, shoulders, etc.).

The machining 772 may involve forming a green tube from the selected tubing. The green tube may be formed into a raw joint by rolling out on a feed rack, forging (e.g., heating in an induction coil heating assembly to forging temperature), and transporting to an upsetter as shown in further detail in FIGS. 7B1-7B2. This process may be performed to provide full body normalizing of the tubing, and to produce uniform grain structure throughout the entire tubing.

The green tube may be shaped by rolling on the feed rack. During rolling, the green tube may be pierced and stretched to provide a desired tube length, such as from about 16 ft (4.88 m) to about 25 ft (7.62 m), from about 1.25 ft (0.38 m) to about 34 ft (10.36 m), from about 2 ft (0.61 m) and 34 ft (10.36 m) to about 48 ft (14.63 m).

In preparation for upsetting, ends of the green tube may be heated either in single or in a multiple progression by inserting into a heating oven, such as an induction coil system. During forging, the selected tubing may pass through multiple induction heating furnaces where it is heated to a forging temperature, hot reduced to ordered size, and air cooled. The oven may have multiple temperatures for heating the green tube to achieve desired casing performance characteristics. In an example, a selected forging temperature may be about above 1650 F (899 C), for example, between about 2150 F and 2300 F (1177-1260 C).

In preparation for upsetting, the green may pass through an oven to heat the end(s) from an ambient temperature to a specific temperature range (e.g., from about 2150-2300 F (1177-1260 C)). The end may be positioned in one part of the oven to reach a first temperature, and then moved to one or more other parts to reach one or more other temperatures until a specified temperature is reached. The depth of heating within the oven may be determined by a length of upset that is to be made. For example, the forging may involve heating the ends in a mold to a forging temperature of from about 2160 F (1182 C) to about 2300 F (1260 C) for about a duration of from about 50 to about 120 seconds, and induction heating for about 7 seconds.

Once the forging temperature is reached, the green tube is sent to the upsetter to upset the ends. The length of time between leaving the oven and performing the upset may be defined to provide upsetting at a desired temperature. This time and the forging temperature may be selected according to tubing specifications (e.g., size, weight, type, maker, etc. of the tubing). For example, the time between forging and upsetting may be from about 5 to about 25 seconds.

For seamless applications, the tubing may be turned into a tube shell in a rotary piercing mill as the preheated tubing is cross-rolled between two barrel-shaped rolls at a high speed. A bullet shaped piercer point may be pushed through the middle of the tubing as it is being rolled to smooth and confirm the shape of its internal passage. The tubing may enter a mandrel mill, where it is stretched and rolled into a shell of controlled dimension. The shells may then be reheated for final forming in a hot stretch reduction mill where dimensions (e.g., OD, wall thickness, etc.) are formed to specifications. The seamless tubing may then be cooled and the tubing cut to length to form a seamless green tube.

For ERW tubing, the steel may be uncoiled and leveled, and passed through a series of forming rolls, which transform the steel into tubing with a slit along a length thereof. The steel may be contoured for seam welding along the slit to close the tubing. The weld may be created by heat obtained from the tubing's resistance to the flow of electric current of the circuit of which it is part, and by applied pressure. Extraneous metal is not required in the welding process. After the flash (metal extruded by the weld process) is removed from the tubing's inside and outside surfaces, the tubing may be cut to length to form the ERW green tube. Weld integrity may be inspected, for example, by ultrasonic test equipment just after the welding process.

The forming 774 may involve positioning one or both ends of the tubing in an upsetter to shape the end(s). The upsetting process may involve molding, punching, compressing, shaping, heating, removing, cooling, and/or inspecting the end(s) of the tubing. If needed (e.g., for dual upset casing joints)), the process may be repeated until the desired dimensions and/or characteristics are achieved. The tubing may be cut off and the process repeated as needed. In some cases, the machining 772 and the forming 774 may both need to be repeated. Once approved, the upset tubing may be transported for heat treatment.

Once heated during machining 772, the end(s) are conveyed into an upsetter for shaping. The upsetter may be of many different types and designs, such as an upsetter commercially available from AJAX CECO™ at www.ajax-ceco.com, NATIONAL™ at www.metalist.com, KOBELCO™ at www.kobelco.co.jp, etc. The upsetter may have sufficient mechanical strength to handle the various sizes, gripping capacities and lengths of upsets required, as well as lubrication for applying various types of lubricating oils to the dies that are used within the upsetter.

The end may be positioned in a die and clamped in place and maintained at an elevated temperature. The die may have inserts that define the shape of the upset end, and a punch that is mechanically inserted into the end. The inserts may be shaped to generate the shape of the upset ends, such as those of FIGS. 3A-3C.

While positioned in the upsetter, the punch is inserted into the end of the raw joint while in the die to cause the material to deform to the dimensions of the die or mold. This may take one or more insertions (or hits). Depending on the punch and die it may increase or decrease the diameter of the material, lengthen or shorten the material, increase or decrease the wall thickness or any type of process required to change the material shape of the end to that which is set up by the die and punch. One or more punches may be used to achieve the desired upset end.

Variations in the upset ends may be generated with various upsetter configurations. The upset design defines the type of connection that may be generated in the green tubing. The upset design may determine the design of the die that may be used in the upsetter. Specific designs of dies may be required for specific type of upsets on particular sizes and weights of material.

By way of example, the upsetter may have die blocks of about 52 in (132.08 cm) long (external) with inserts that fit inside the die blocks grips make up 1/9 in (0.28 cm) of tool space. The inserts and punches may be made of H-13 tool steel with nitride or other wear resistant material. Graphite may be sprayed onto the die and/or punch during punching.

Depending on the complexity of the upsetter, multiple dies may be used within the same operation with the green tube being moved from one die to the next while within the upsetter. This process may cause the end to be forged during the upsetting. By doing this the material properties of the ends may allow adjustment of the mechanical properties of the ends to conform to those of the tubular portion, thereby providing consistent mechanical characteristics throughout the green tube. This may also apply whether green tube is formed from seamless or ERW tubing.

After upsetting, the green tube is then removed from the upsetter and allowed to cool on pipe racks or other storage area. The treated end is now referred to as the upset end. The upset end may be of a dimension that is the same or different from API or other sized couplings. Upsetting may be performed on one end, and the green tube rotated to allow upsetting on the other end. In some cases, the other end may be provided with other connections, such as alternative connections and/or standard T&C connections.

Upon completion of the desired upsetting, a raw joint is formed. The raw joint may be reprocessed through 772 and/or 774, or continue on to forming 776. After cooling and/or upsetting, the upset tube may be straightened, visually inspected, stenciled with the appropriate identify and queued for finishing or quench and temper, laboratory tests confirm full compliance to specifications and other mechanical property requirements before upset tube is beveled, electromagnetically inspected and hydrostatically tested. Subsequent inspections may be done to ensure no deficiencies in the green tube and/or raw joint. If ERW tubing was used, additional inspections may take place to ensure that the weld line is no longer an issue.

Once the upsetting process is concluded, the raw joint may be inspected and dimensioned. The raw joint may then undergo one or more cycles of forging, cooling, straitening, testing, and/or inspecting.

The forming 776 may involve heat treating the raw joint to alter its physical and/or chemical properties to provide a specific grade of casing. The raw joint may be conveyed into an austentizing furnace and heated to a heating temperature of about 1550 F (843 C) and then cooled with an outside diameter water quench of below about 200 F (93 C). After entering the tempering furnace, precise control of the temperature may be used to control the mechanical properties along the length or the raw joint. The raw joint may travel through a multi-roll opposing pipe straightener and then on to cooling. The cooling may be performed in a quenching unit, tempering furnace, and/or cooling bed. The cycles may be performed at desired temperatures, such as heating to about 500 F (260 C) and quenching to about 200 F (93 C). The raw joint is now a completed joint and may then proceed to finishing 778.

The finishing 778 may involve inspecting, sorting, threading, drifting, measuring, weighing, grading, coating, stenciling, repairing, and/or adding features (e.g., seals, hardeners). Once completed and inspected, the finished joint may be certified for use as a casing joint.

Completed joints may be tested to ensure that all sections pass for the requirements of the grade that was requested. For example, prior to threading, Electromagnetic Inspection (EMI)/Ultrasonic Testing (UT) unit and a Special End Area (SEA) inspection unit may be used to detect longitudinal and transverse indications and to provide a measurement of wall thickness. The completed joint may then be pressure tested and sent for threading. The completed joint may also be pressure tested and sent to cutoff, facers and threaders for end finishing. Before shipping to end user, the completed joint may also be full-length drifted, grade-verified, length measured, weighted, stenciled and coated.

The end may be threaded to form a threaded end. The threading process may vary from one facility to the next and may use different types of connections/couplings/material and equipment. The completed joint may have a torque shoulder cut into the box end (e.g., 319 of FIG. 3A) that defines a buttress connection (BTX) and/or long connection (LTX). The dimensions of the threaded ends may be similar to that of API couplings (e.g., 214 of FIG. 2), with conventional threading. Such connections may be provided controlled yield of the upset area, angled, square or tapered shoulder, torque shoulder and maintain interchangeability with API connections.

The method may involve other optional procedures. For example, additional testing may be done at other stages of the method (e.g., at the upset) to ensure that the material throughout the upset meets the requirement of the specified grade. The upsetting may be repeated for another end of the completed joint. Additional features may be applied to the completed joint at finishing. For example, additional torque features, pressure integrity seals, mechanical integrity seals, etc. may be added.

The methods 700a,b may be used to provide various configurations of integrated casing joints. The final casing joints may have one or more varying tube sizes and grades (e.g., inner and/or outer diameters) at one or more locations along its length. The casing may be many of different sizes and weights such as but not limited to sizes such as 2.375, 2.875, 3.500, 4.000, 4.500, 5.000, 5.500, 5.875, 6.625, 7.000, 7.625, 7.750, 8.625, 8.750, 9.625, 9.750, 9.875, 10.750, 11.750, 11.875, 13.375, 13.500, 13.625, 14.000, 16.000, 18.625, 20.000, 24.000 inches (6.03, 7.30, 8.89, 10.16, 11.43, 12.7, 13.97, 14.92, 16.83, 17.78, 19.37, 19.69, 21.91, 22.23, 24.45, 24.77, 25.08, 27.31, 29.85, 30.16, 33.97, 34.29, 34.61, 35.56, 40.64, 47.31, 50.8, 60.96 cm). The grades of the casing may be such as (e.g., L-80, N-80, C-90, R-95, T-95, C-110, P-110, Q-125, S-135, 140, 150 or any combination as required.

The method 700c involves 780—providing an integrated casing joint. The integrated casing joint may comprise a tubing having upset ends formed integrally therewith with the features described herein, such as 1) material comprising carbon manganese, silicone, chrome, molybdenum, and aluminum, 2) consistent mechanical properties (e.g., similar or equivalent tensile and torsional strength) along the tubular portion and at the end(s), and 3) upset end(s) having an enlarged outer diameter. The method also involves 782—forming an integrated casing string by coupling (e.g., threading) one of the upset ends of the integrated casing joint with an end of another integrated casing joint, 784—advancing the integrated casing string into the wellbore, and 786—cementing the integrated casing string in the wellbore.

### Integrated Performance

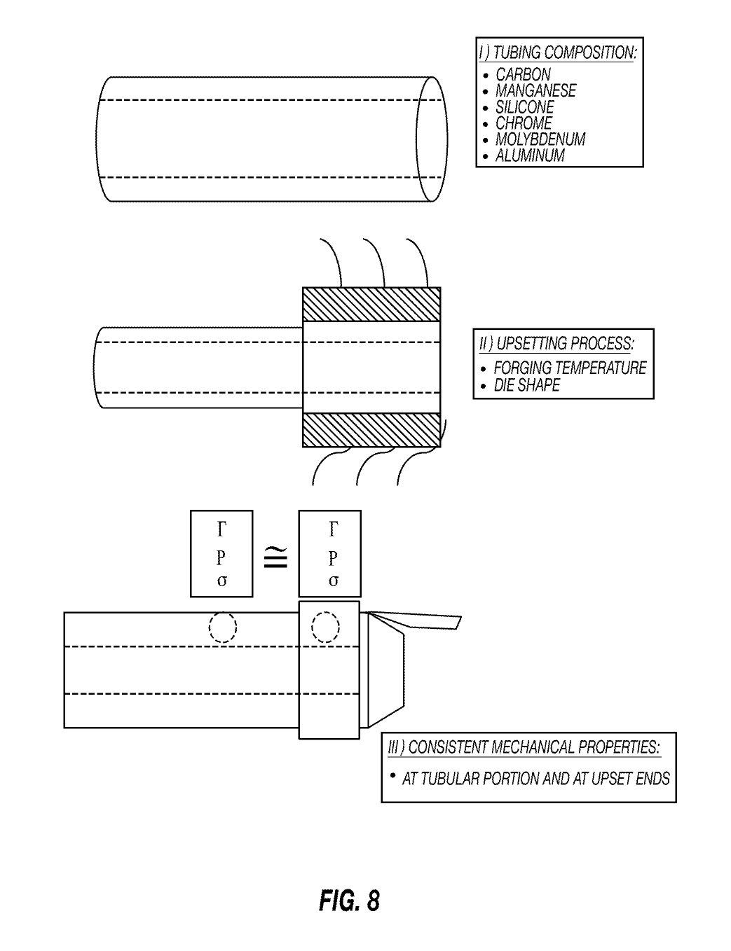

The integrated casing joint may be formed using tubing using a combination of: I) a selected metallurgy of the tubing (e.g., tubing comprising a combination of Carbon, Manganese, Silicon, Chrome, Molybdenum, and Aluminum), II) using the upsetting process at specified conditions (e.g., upsetting at select forging temperatures and mold dimensions as provided in FIGS. 7A and 7B1-7B2), III) to achieve the consistent mechanical properties (e.g., torque strength F, tensile strength a, and compression pressure strength P) between the tubular portion and the ends as schematically shown by FIG. 8. This combination may be used to generate a result casing joint with enhanced casing performance characteristics, such as increased makeup torque, tensile, and pressure ratings as set forth in the examples below:

### Example 1—Single Upset Integrated Casing

A single upset, integrated casing joint is provided for casing performance testing. The casing joint is of a similar structure as shown in FIG. 3A and is formed a connection with an adjacent casing joint as shown in FIG. 4A.

The casing joint is a 5.5 inches (13.97 cm) 23.00 lb (10.43 kg) P-110 BTU casing joint. The casing joint has an upset box end with an outer diameter of 6.050 inches (15.37 cm). The casing joint comprises the following metallurgy as set forth in Tables 3 below:

TABLE 3
CASING JOINT METALLURGY

| Element | Min | Max |
|---|---|---|
| Carbon | 0.2200 | 0.2900 |
| Manganese | 0.7000 | 1.4500 |
| Phosphorus | — | 0.0150 |
| Sulfur | — | 0.0100 |
| Silicon | 0.1500 | 0.3500 |
| Copper | — | 0.2000 |
| Nickel | — | 0.0800 |
| Chrome | 0.3000 | 1.2000 |
| Molybdenum | 0.1500 | 0.5000 |
| Tin (Sn) | — | 0.0200 |
| Aluminum | 0.0200 | 0.0500 |
| Vanadium | 0.0100 | 0.0500 |
| Niobium | — | 0.0100 |
| Titanium | — | 0.0100 |
| Boron | — | 0.0010 |
| Nitrogen | — | 0.0120 |

The casing joint is formed using the methods of FIGS. 7A and 7B1-7B2, with the single upset formed at an end of the tubing using a forging temperature of about 2150-2300 F (1177-1260 C) for about 50-120 seconds and upset within about 5-25 seconds. The resulting casing joint has consistent mechanical properties at the tubular portion and the upset ends as set forth in Tables 4-6 below:

TABLE 4
PIPE BODY DATA

| | English Units | SI Units |
|---|---|---|
| Outside Diameter | 5.5 in | 13.97 cm |
| Nominal Weight (T&C) | 23 lb/ft | 10.43 kg/30.48 cm |
| Wall Thickness | 0.415 in | 1.05 cm |
| Nominal ID | 4.670 in | 11.86 |
| Steel Grade: P110 | n/a | n/a |
| API Drift | 4.545 in | 11.54 cm |

TABLE 5
PIPE BODY PERFORMANCE

| | English Units | SI Units |
|---|---|---|
| Min Yield Strength | 110,000 psi | 7735.6 Kg/cm |
| Tension Yield | 729,000 lbs | 330,669 kg |
| Available seamless: YES | n/a | n/a |
| Max Yield Strength | 140,000 psi | 9845.3 Kg/cm |
| Internal Pressure Yield | 14,520 psi | 1021.1 Kg/cm |
| Available welded: YES | n/a | n/a |
| Min Tensile Strength | 125,000 psi | 8790.4 Kg/cm |
| Collapse Pressure | 14,540 psi | 1022.5 Kg/cm |
| Performance based on | n/a | n/a |
| 100% RBW | | |

TABLE 6
CONNECTION DATA

| | English Units | SI Units |
|---|---|---|
| Type: RDT BTX | n/a | n/a |
| Pressure Capacity | exceeds pipe | exceeds pipe |
| Tension Yield | exceeds pipe | exceeds pipe |
| Pin Connection OD | 5.5 in | 13.97 cm |
| Pin Connection ID | 4.670 in | 11.86 cm |
| Box Connection OD | 6.050 in | 15.37 cm |
| Make-up Torque min | 10,000 ft-lbs | 13,558.18 N-m |
| Makeup Torque optimum | 23,000 ft-lbs | 31,183.8 N-m |
| Make-up Torque Yield | 37,000 ft-lbs | 50,165.26 N-m |

### Example 2—Dual Upset Integrated Casing

A dual upset, integrated casing joint is provided for casing performance testing. The casing joint is of a similar structure as shown in FIG. 3C and is formed a connection with an adjacent casing joint as shown in FIG. 4B.

The casing joint is a 4.5 inches (11.43 cm) 23.00 lb (10.43 kb) P-110 BTU casing joint. The casing joint has an upset box end with an outer diameter of 6.050 inches (15.37 cm). The casing joint comprises the following metallurgy as set forth in Tables 3 above.

The casing joint is formed using the methods of FIGS. 7A and 7B1-7B2, with the single upset formed at an end of the tubing using a forging temperature of about 2150-2300 F (1177-1260 C). The resulting casing joint has consistent mechanical properties at the tubular portion and the upset ends as set forth in Tables 7-9 below:

TABLE 7
PIPE BODY DATA

| | English Units | SI Units |
|---|---|---|
| Outside Diameter | 4.5 in | 11.43 cm |
| Nominal Weight (T&C) | 13.5 lb/ft | 6.12 kg/30.48 cm |
| Wall Thickness | 0.290 in | 0.74 cm |
| Nominal ID | 3.920 in | 9.96 cm |
| Steel Grade: P110 | n/a | n/a |
| API Drift | 3.795 in | 9.6393 |

TABLE 8
PIPE BODY PERFORMANCE

| | English Units | SI Units |
|---|---|---|
| Min Yield Strength | 110,000 psi | 7735.6 Kg/cm |
| Tension Yield | 422,000 lbs | 191,416 kg |
| Available seamless: YES | n/a | n/a |
| Max Yield Strength | 140,000 psi | 9845.3 Kg/cm |
| Internal Pressure Yield | 12,420 psi | 873.42 Kg/cm |
| Available welded: YES | n/a | n/a |
| Min Tensile Strength | 125,000 psi | 8790.4 Kg/cm |
| Collapse Pressure | 10,680 psi | 751.05 Kg/cm |
| Performance based on | n/a | n/a |
| 100% RBW | | |

TABLE 9
CONNECTION DATA

| | English Units | SI Units |
|---|---|---|
| Type: RDT BTX | n/a | n/a |
| Pressure Capacity | exceeds pipe | exceeds pipe |
| Tension Yield | exceeds pipe | exceeds pipe |
| Pin Connection OD | 4.5 in | 11.43 cm |
| Pin Connection ID | 3.920 in | 9.96 cm |
| Box Connection OD | 5.000 in | 12.7 cm |
| Make-up Torque min | 12,500 ft-lbs | 16,947.72 N-m |
| Makeup Torque optimum | 13,500 ft-lbs | 18,303.54 N-m |
| Make-up Torque Yield | 20,000 ft-lbs | 27,116.36 N-m |

The above description is illustrative of example embodiment and many modifications may be made by those skilled in the art without departing from the disclosure whose scope is to be determined from the literal and equivalent scope of the claims that follow.

While the embodiments are described with reference to various implementations and exploitations, it will be understood that these embodiments are illustrative and that the scope of the inventive subject matter is not limited to them. Many variations, modifications, additions and improvements are possible, such as various combinations of the features and/or methods described herein.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

Insofar as the description above and the accompanying drawings disclose any additional subject matter that is not within the scope of the claim(s) herein, the inventions are not dedicated to the public and the right to file one or more applications to claim such additional invention is reserved. Although a very narrow claim may be presented herein, it should be recognized the scope of this invention is much broader than presented by the claim(s). Broader claims may be submitted in an application that claims the benefit of priority from this application.

What is claimed is:

1. An integrated casing joint of a casing string positionable in a wellbore penetrating a subterranean formation, the integrated casing joint comprising:
a tubular portion;
a pair of tubular joint ends positionable at opposite ends of the tubular portion, at least one of the pair of tubular joint ends comprising an upset end integrally formed with the tubular portion, the upset end having equivalent mechanical strength with the tubular portion, the upset end matably connectable to one of the pair of tubular joint ends of an adjacent casing joint to define an integrated casing connection therebetween whereby casing performance is optimized.

2. The integrated casing joint of claim 1, wherein the upset end comprises a box end having an outer diameter larger than an outer diameter of the tubular portion with a tapered shoulder defined therebetween.

3. The integrated casing joint of claim 2, wherein the other of the pair of tubular joint ends comprises a pin end, the pin end being one of an upset pin end and a coupled pin end.

4. The integrated casing joint of claim 1, wherein the upset end has a tapered inner surface with a minimum inner diameter larger than an inner diameter of the tubular portion with an internal shoulder defined therebetween.

5. The integrated casing joint of claim 3, wherein the internal shoulder is one of perpendicular, tapered, angled, and curved.

6. The integrated casing joint of claim 1, wherein at least one of the pair of tubular joint ends has threads matably connectable to threads of at least one of the pair of tubular joint ends of another adjacent casing joint.

7. The integrated casing joint of claim 1, wherein the upset end further comprises a hardener.

8. The integrated casing joint of claim 1, wherein the tubular portion comprises at least one of a green tube, a seamless tube, a flat metal rolled into a tube, and a seamed tube.

9. The integrated casing joint of claim 1, wherein the tubular portion comprises a metal alloy, the metal alloy comprising at least one of between 0.22 and 0.29 Carbon, between 0.7 and 1.45 Manganese, between 0.15 and 0.35 Silicon, between 0.30 and 1.20 Chrome, between 0.15 and 0.5 Molybdenum, and between 0.02 and 0.05 Aluminum, and combinations thereof.

10. The integrated casing joint of claim 1, wherein the equivalent mechanical strength comprises at least one of torque strength, tensile strength, compression pressure strength, and combinations thereof.

11. An integrated casing assembly positionable in a wellbore penetrating a subterranean formation, the integrated casing assembly comprising:
a plurality of casing joints matingly connected in series to form a casing string, each of the plurality of casing joints comprising:
a tubular portion;
a pair of tubular joint ends positionable at opposite ends of the tubular portion, at least one of the pair of tubular joint ends comprising an upset end integrally formed with the tubular portion, the upset end having equivalent mechanical strength with the tubular portion, the upset end matably connectable to one of the pair of tubular joint ends of an adjacent casing joint to define an integrated casing connection therebetween whereby casing performance is optimized.

12. The integrated casing assembly of claim 11, wherein at least one adjacent pair of the plurality of casing joints comprises integrated casing joints defining an integrated connection therebetween.

13. The integrated casing assembly of claim 11, wherein at least one adjacent pair of the plurality of casing joints comprise coupled casing joints defining a coupled connection therebetween.

14. The integrated casing assembly of claim 13, further comprising at least one coupling connectable between the at least one adjacent pair of the coupled casing joints.

15. The integrated casing assembly of claim 11, wherein each of the plurality of casing joints have different diameters telescopically connected together.

16. The integrated casing assembly of claim 15, wherein the plurality of casing joints define a variable casing string length.

17. The integrated casing assembly of claim 11, further comprising a seal between the plurality of casing joints.

18. The integrated casing assembly of claim 11, wherein the adjacent casing joint has an adjacent end receivable in the upset end.

19. The integrated casing assembly of claim 18, wherein the adjacent end has a tapered outer surface with a shoulder shaped to receivingly engage the upset end.

20. The integrated casing assembly of claim 18, wherein the upset end has an outer diameter larger than an outer diameter of the adjacent end to define a step therebetween.

21. A method of performing an integrated casing operation for a wellbore penetrating a subterranean formation, the integrated casing operation comprising:
providing an integrated casing joint comprising:
a tubular portion;
a pair of tubular joint ends positionable at opposite ends of the tubular portion, at least one of the pair of tubular joint ends comprising an upset end integrally formed with the tubular portion, the upset end having equivalent mechanical strength with the tubular portion;
forming an integrated casing string by matingly connecting at least one of the pair of tubular joint ends of the integrated casing joint with an end of another casing joint;
advancing the integrated casing string into the wellbore, and
cementing the integrated casing string in the wellbore.

22. The method of claim 21, wherein the providing comprises:
forming the integrated casing joint by:
machining a green tube from a tubing material;
forming a raw joint by upsetting at least one end of the green tube;
forming a completed joint by heat treating the raw joint; and
finishing the completed joint.

23. The method of claim 22, wherein the machining comprises rolling out the tubular portion and heating the tubular portion to a forging temperature.

24. The method of claim 22, wherein the forming the raw joint comprises forging the upset end in an upset mold at a forging temperature, cooling the upset end to ambient temperature, and inspecting the upset end.

25. The method of claim 22, wherein the forming the completed joint comprises heating the raw joint and cooling the raw joint.

26. The method of claim 22, wherein the finishing comprises at least one of applying threading, hardener, stenciling, coating, inspecting, measuring, weighing, grading, drifting, and combinations thereof.

27. The method of claim 21, further comprising supporting the integrated casing string during connection with an integrated casing connection.

28. The method of claim 21, further comprising maintaining connection between adjacent casing connections during application of forces to the integrated casing string.

29. The method of claim 21, further comprising heat treating and finishing the tubular portion and the pair of tubular joint ends.
